(19) United States
(12) Patent Application Publication
(10) Pub. No.: US 2012/0109872 A1
(43) Pub. Date: May 3, 2012

(54) WIRELESS MOTION SENSOR NETWORK FOR MONITORING MOTION IN A PROCESS, WIRELESS SENSOR NODE, REASONING NODE, AND FEEDBACK AND/OR ACTUATION NODE FOR SUCH WIRELESS MOTION SENSOR NETWORK

(76) Inventors: Paul Johannes Mattheus Havinga, Saasveld (NL); Raluca Sandra Marin-Perianu, Enschede (NL); Mihai Marin-Perianu, Enschede (NL)

(21) Appl. No.: 13/144,672

(22) PCT Filed: Jan. 18, 2010
(86) PCT No.: PCT/NL10/50024

§ 371 Date: Jan. 3, 2012

Related U.S. Application Data
(60) Provisional application No. 61/205,468, filed on Jan. 16, 2009.

(30) Foreign Application Priority Data
Sep. 22, 2009 (NL) 2003524

(51) Int. Cl. G06N 7/02

(52) U.S. Cl. 706/52

(57) ABSTRACT

Wireless motion sensor network for monitoring motion in a process comprising at least one wireless sensor node for measuring at least one physical quantity related to motion or orientation, feature extraction means for deriving a feature for the measured quantities, a wireless transmitter connected to the feature extraction means for transmitting the derived feature, and the wireless receiver receiving derived features from other sensor nodes, the network further comprising a reasoning node for collecting features transmitted by the at least one wireless sensor node comprising a collaborative reasoning engine for determining further features based on features received by a wireless receiver wherein the further features are determined by calculation and/or a rule set; and the wireless motion sensor network comprising a feedback and/or actuation means for intervening in or influencing a monitored process based on the output of the collaborative reasoning engine.

The present invention relates to a wireless motion sensor network for monitoring motion in a process.

The present invention further relates to a wireless sensor node for use in such a wireless motion sensor network.

The invention also relates to a reasoning node for use in such a wireless motion sensor network.

The invention furthermore relates to a feedback and/or actuation node for use in such a wireless motion sensor network.

The systems and methods described herein concern wireless motion sensor networks (i.e. networks composed of wireless sensor nodes equipped with motion sensors), which can create semantic distributed ad-hoc networks, process and exchange motion information, assess the observed situation, provide feedback and take actions, based on logic executed in collaboration.

The object of the present invention is to provide a system for acquiring detailed motion information on a process and further processing the acquired information.

The present invention provides a wireless motion sensor network for monitoring motion in a process comprising:—at least one wireless sensor nodes comprising: at least one sensor for measuring at least one physical quantity related to motion or orientation, feature extraction means connected to the at least one sensor for deriving a feature from the measured quantities, a wireless transmitter connected to the feature extraction means derivation means for transmitting the derived feature, and a wireless receiver for receiving derived features from other sensor nodes;—a reasoning node for collecting features transmitted by the at least one wireless sensor node, comprising: a wireless receiver for receiving transmitted features, a collaborative reasoning engine for determining further features based on features received by the wireless receiver, wherein the further features are determined by calculation and/or a rule set comprising at least one rule,—feedback and/or actuation means for intervening in or influencing the monitored process comprising: communication means for receiving output of a collaborative reasoning engine from a reasoning node, feedback means for providing a feedback signal to an user based on the output of the collaborative reasoning engine, and/or an actuator for controlling a process input based on the output of the collaborative reasoning engine.

A motion sensor typically captures information related to the kinematic motion that the sensor is subjected to. Examples of motion sensors include inertial sensors such as accelerometers, tilt-switches and gyroscopes. However, in the present application a motion sensor is any sensor that can provide, directly or indirectly, useful information with respect to its motion, orientation or position. Examples include magnetometers (also referred to as magnetic compasses or simply compasses), pressure sensors, load cells, acoustic sensors, infrared sensors, Global Positioning System (GPS) receiver.

By attaching the sensor nodes to parts of an entity in motion, motion information is gathered from the individual parts. In a preferred embodiment the sensor nodes periodically sample the sensor outputs and temporarily store the output in a local buffer that holds a number of previous samples in order to allow the sensor node to perform time analysis on the samples. A sensor node processes the stream of motion sensor data and extracts (or measures) application-specific features of interest by means of the feature extraction means. A feature represents any quantitative or qualitative measure that can be extracted from a given sequence of sensor data and that can be used to characterize the data in a systematic way. Examples of application-specific features of interest are: the magnitude of the acceleration vector; any measure from the time domain of motion sensor data (e.g. the maximum, minimum or average amplitude of the acceleration on a specific reference axis); any measure from the frequency domain of motion sensor data (e.g. the dominant frequency of the acceleration signal); orientation and heading (e.g. obtained from the magnetic compass data); tilt angles (e.g. roll and pitch angles); velocity (e.g. obtained by integration of the acceleration vector); distance (e.g. obtained by double integration of the acceleration vector); direction of movement (e.g. up or down movement). In its most simple form a feature is the unaltered, raw sensor output.

A sensor node with sufficient processing power, or a dedicated processing node serves as a reasoning node and collects the derived features from the sensor nodes. Subsequently, the reasoning node derives further measures based on multiple derived features by means of its collaborative reasoning engine. The derived measures are either provided as features, or sent to the feedback and/or actuation means in order to provide feedback.

In one particular embodiment the movement of the leg of a cyclist is monitored (see also FIG. 4): The knee and ankle joint angles (noted with K and A, respectively) can be computed from the roll angles (α, β, δ) derived from the motion of the three nodes in the sagittal plane, as follows:

K=π−α−β

A=β+δ

To compute the knee and ankle joint angles, we have the following options:

a) The nodes on the thigh, shank and foot send the roll angles periodically to a separate feedback device, which determines the joint angles;

b) The node on the shank transmits periodically the roll angle to the nodes on the thigh and foot. Upon receiving the message, the nodes on the thigh and foot compute the knee and ankle angles, respectively (and optionally send the result to a separate feedback device);

c) The nodes on thigh and foot send periodically their roll angles to the node on the shank, which determines both the knee and ankle angles (and then optionally sends them to a separate feedback device).

According to another particular embodiment according to the invention, waves at a body of water are monitored by sensor nodes attached to buoys floating on the water. To have an assessment of the current status of the sea surface, the following steps have to be followed:

a) Each node broadcasts the wave height either (i) to the cluster of nodes present on the water surface or (ii) to a central processing point;

b) The 3D spatial information of sea surface is computed by either (i) a designated subset of the cluster of nodes on the sea surface or (ii) the central processing point.

Feedback means is any interfacing device that can connect to the wireless motion sensor network and inform a user about, for example, the current motion features, the evolution of the motion features in time and/or any feedback regarding the observed situation and suggestion for action. Examples of feedback means are: computer, TV, display, personal digital assistant (PDA), mobile phone, speakers, etc.

The present invent further provides a wireless motion sensor network, wherein the sensor node further comprises: semantic property derivation means for deriving a semantic property based on at least one of: raw sensor data, a derived feature, a confidence measure computed from at least one feature, and the proximity to other sensor nodes, and wherein the wireless transmitter is connected to the semantic property derivation means for transmitting the derived semantic property; the wireless receiver is further configured to receive semantic properties from other sensor nodes; the sensor node further comprising: clustering means connected to the semantic properties derivation means and the wireless receiver for dynamically forming clusters with other sensor nodes based upon common semantic properties.

The wireless motion sensor network autonomously organises into clusters (i.e. groups) of nodes that have related semantic properties. The relationship among nodes may, in one embodiment, be expressed through functions. For being able to deduce the relationships among semantic properties, each node broadcasts the semantic properties of interest to the neighbours. A simple example of semantic relationship is that the nodes move together or in a similar way, i.e. the nodes are in a similarity of movement relationship. Examples of functions that can be used to assess the similarity of semantic properties are the following: equality relation; if the semantic properties lie within a specified interval; if the absolute difference between the semantic properties from two different nodes is less than a threshold value; the correlation coefficient between a time series of semantic properties (e.g. the magnitude of the acceleration vector during a time interval); a coherence function that indicates whether the two signals are correlated at a particular frequency.

The clustering means can be used to establish which wireless sensor nodes take part in a particular collaborative reasoning, i.e. from which wireless sensor nodes the reasoning node collects features. Considering the example of monitoring the movement of the leg of a cyclist, the cluster is formed by the nodes attached to the thigh, shank and foot, and only their features are used in the collaborative reasoning to compute the knee and ankle joint angles.

The present invention provides a further embodiment comprising a wireless motion sensor network, wherein the collaborative reasoning engine only combines derived features originating from sensor nodes from a common cluster.

In another embodiment a wireless motion sensor network is provided, wherein the sensor node and the reasoning node are combined into a single node. Furthermore, the invention provides a wireless motion sensor network, wherein the reasoning node and the feedback and/or actuation node are combined into a single node. In a further embodiment, the present invention provides a wireless motion sensor network, wherein the clusters formed as described above form a first hierarchical level, and wherein the sensor nodes are configured to form a higher level cluster by clustering the nodes of two lower level clusters that have at least one sensor node in common.

Clusters can be built at different levels of abstraction, depending on the semantic properties used as the clustering criteria. The nodes in level 1 clusters are related through only one semantic property. Clusters from level 2 have a first set of members related through one semantic property, while the rest of the members (second set) are related through a different semantic property. The condition on which level 2 clusters are constructed is that there exists at least one node from the cluster that is related through the first semantic property with the first set of members and through the second semantic property with the second set of members. This node is called a gateway node. In a similar way, level n clusters can be constructed, on the condition that gateway nodes are present to link the clusters and their corresponding semantic properties.

In one embodiment a reasoning node in a lower level cluster determines a further feature based on the derived features of the sensor nodes in the lower level cluster and provides the further feature to a higher level cluster, where the further feature is used as input for further collaborative reasoning.

According to another embodiment of the present invention, a wireless motion sensor network is provided, wherein a sensor node determines whether the node is in one of the following states when the sensor node undergoes a repetitive motion:—a static reference position characterised by a sensor output showing or at least hinting at the absence of motion;—an extreme position characterised by a sensor output showing or at least hinting at the sensor having reached a minimum or a maximum position within a range of motion; and—a continuous motion characterised by a sensor output showing or at least hinting at the sensor being in motion between two extreme positions.

A repetitive motion is any motion repeated at (not necessarily equal) time intervals. We consider periodic motion (when the time interval for a repetition is constant) as a special case of repetitive motion. With respect to the repetitive motion of an entity, we assume that there are several phases:

1) Static reference position. This can be seen as the initial state of an entity, before the motion begins. However, static reference positions may occur not only in the initial state, but also later on, interleaved with the actual motion. A static reference position can always be determined by computing for example the variance of one or more motion sensor measurements (e.g. the magnitude of the acceleration vector ∥a∥) over a sliding time window and comparing it with a pre-defined threshold:

IF var(∥a∥)<Threshold THEN static reference position is detected

2) Min-max positions. These correspond to the two extreme points between which the repetitive motion of the entity takes place. For example, in the case of a motion of the lower limbs of a cyclist, the min-position can be defined as the pedal bottom position (or 6 o'clock position) and the max-position can be defined as the pedal top position (or 12 o'clock position). For clarity, the min-max positions should not be regarded as rigidly confining the motion between two fixed points in space, but as two positions that remain roughly the same in time and that roughly define the range of motion in a specified frame of reference.

3) Continuous motion. This is the actual motion taking place between the min and max positions. During continuous motion, the sensor nodes are continuously performing the operations of sampling the motion information from the sensors and determining features based on the sensor data.

In a further embodiment, the present invention provides a wireless motion sensor network, wherein a sensor node calibrates a sensor or a feature during a determined static reference position by making use of the knowledge that the sensor node is motionless.

Sensors may build-up an error due to drifting phenomena, for example in integrating processes. By recalibrating sensors or features based on the presence of a known position, this error can be minimised.

In one particular embodiment a sensor node calibrates its orientation with respect to a fixed reference frame by determining the tilt of the sensor node using the accelerometer readings and the heading (or azimuth) by using the compass readings.

In again a further embodiment, a wireless motion sensor network is provided, wherein the sensor node calibrates a sensor or a feature by assuming a value at a determined extreme position. For example, if a part is making a circular movement, the vertical speed is zero in the top and bottom positions of the circular path. So if a top or bottom position is detected, the vertical speed is reset to zero (for example when speed is a feature that is determined by integrating an acceleration read from an accelerometer). The functionality of resetting a value to an assumed (or known) value will be referred to as measurement reset.

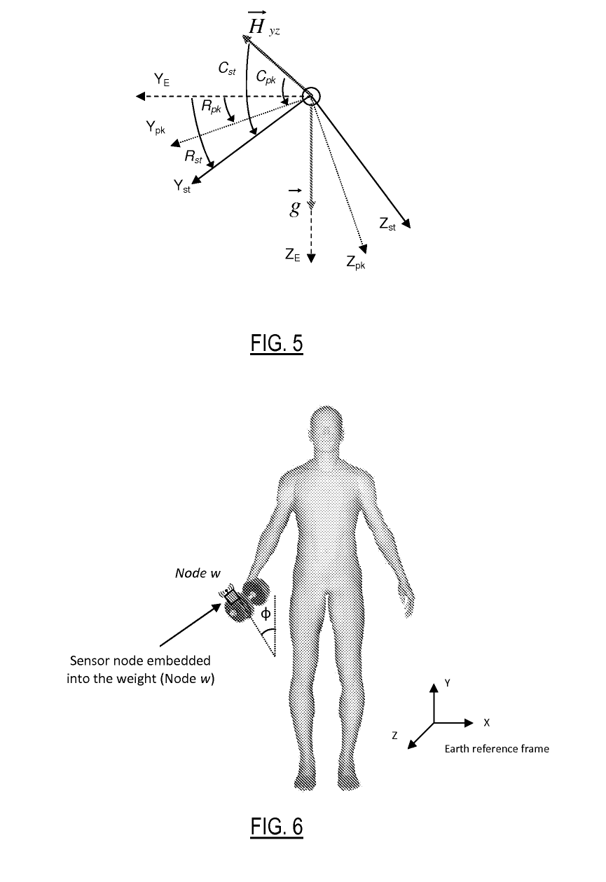

Considering the example of monitoring the movement of the leg of a cyclist, the measurement reset is performed as follows (see also FIG. 5). The roll angle of each sensor node is reset to a value computed from the readings of the compass sensor. The reset is applied at the peak of the roll angle, i.e. when the roll angle is at the min or max position (the lower limb is either pedal-up or pedal-down). If we denote with st the values obtained during the static reference position and with pk the values when reaching the min or max (peak) roll angle position, we compute the new roll angle as:

Rₚₖ=Rₛₜ−arctan(C_{z,st},C_{y,st})+arctan(C_{z,pk},C_{y,pk})

where C_{z,st}, C_{y,st} represent the values measured by the magnetic compass sensor along its Z and Y axes at the static reference position, and C_{z,pk}, C_{y,pk} represent the values measured by the magnetic compass sensor along its Z and Y axes when reaching the min or max (peak) position.

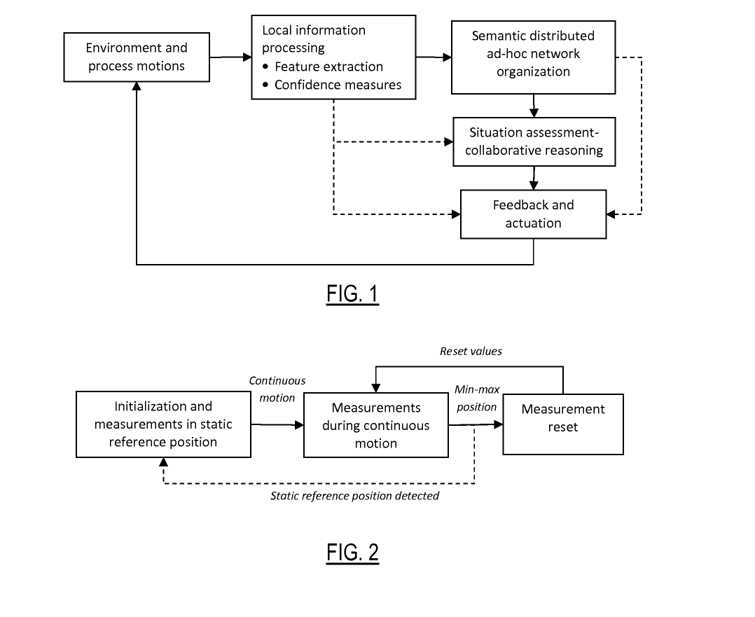

FIG. 2 shows a flow chart for measuring features in repetitive motions. Firstly, initialization of measurements is done in static reference position. Then, measurements are preformed during continuous motion. The measurement reset is done when a condition occurs (e.g. for example at the min-max positions) that a value of the measurement is a priori known from the specifics of the process or can be measured without the risk of an accumulation of errors. If a static position is detected, measurements can be re-initialized (dotted line).

In another embodiment, a wireless motion sensor network is provided, wherein the sensor node further comprises: a local reasoning engine connected to the feature extraction means for determining a confidence measure expressing the confidence that a particular situation has occurred based upon a reasoning process, the local reasoning engine being further connected to the wireless transmitter for transmitting the confidence measure.

The advantage of this embodiment is the characterisation of the features in a more specific manner with respect to the application logic. This characterisation is expressed through the confidence measure, which represents the output of the reasoning step. In other words, through the reasoning step, the features are already processed by the nodes, thus leveraging the burden on the collaborative reasoning process and potentially reducing the amount of data communicated.

Considering a weight lifting exercise (see FIG. 6), assume that a sensor node w, embedded into a weight, computes the basic feature φ—the inclination angle with respect to the Y axis in the Earth reference frame. Node w also reasons upon this basic feature, reaching a partial understanding of the observed situation, with a certain confidence. Node w can infer whether the weight is lifted correctly, from a minimum angle φₘᵢₙ to a maximum angle φₘₐₓ, without exceeding these limits (e.g. φₘᵢₙ=0°, φₘₐₓ=180°. This is inferred by comparing the consecutive local minimum and local maximum of φ (φₘᵢₙ_{_{—}}₁ and φₘₐₓ_{_{—}}₁) to φₘᵢₙ and φₘₐₓ, respectively. The larger the differences |φₘᵢₙ−φₘᵢₙ_{_{—}}₁| and |φₘₐₓ_{_{−}}₁−φₘₐₓ|, the more erroneous the execution of the exercise and thus the lower the confidence measure.

Although features are expressed in some embodiments as crisp numbers, in alternative embodiment, a wireless motion sensor network is provided, wherein a determined feature is expressed as a fuzzy variable comprising at least one fuzzy value.

In a further embodiment, a wireless motion sensor network is provided, wherein a fuzzy variable of a feature is used in the collaborative reasoning engine of a reasoning node as an antecedent to a fuzzy if-then implication that outputs a fuzzy output.

Another embodiment provides a wireless motion sensor network, wherein multiple fuzzy variables are aggregated into a single fuzzy output through a fuzzy inference process.

The present invention also provides a wireless motion sensor network, wherein a fuzzy output is defuzzified to a crisp output. Once defuzzified, the variable is suitable for serving as input to the feedback and/or actuating means.

In one particular embodiment, the present invention provides a wireless motion sensor network, wherein a sensor node determines an amount of turn by determining the angle between a first orientation of the sensor node and a second orientation of the sensor node, and wherein the sensor determines a composite measure (Σ) comprised of the weighted summation of the magnitude of the observed acceleration (A) and the determined amount of turn (θ), wherein the weighting is performed with a weighting function (f(θ)) dependent on the amount of turn (θ); and the composite measure (Σ) is provided as a feature.

The composite measure (Σ) is an adaptive combination of two motion features which is suitable for establishing whether two or more sensor nodes are in a similarity of movement relationship, which is used in a preferred embodiment for clustering the sensor nodes. The composite measure (Σ) is based on:

1) The magnitude of the acceleration vector, which is computed as:

A=\sqrt{Aₓ²+A_{y}²+A_{z}²}

where Aₓ, A_{y}, A_{z} represent the acceleration values measured by the accelerometer sensor along its X-Y-Z axes. Typically, an average value of the acceleration magnitude A over a sliding time window is used. For computational efficiency, the squared value of the acceleration magnitude A² can be used instead of the square root, without affecting the correlation result.

2) The amount of turn, which is computed as the angle between two orientations of the sensor node at two different moments in time.

Each motion feature is appropriate and responsive for a certain motion component, namely:
The acceleration magnitude registers well linear accelerations;
The amount of turn registers well rotation motion components.

The composite measure E combines the advantages of both motion features. In one particular embodiment the composition is done as an adaptive weighted average:

Σ=f(θ)A+(1−f(θ))θ

where f(θ) is a weighting function yielding results in the interval [0,1], closer to 0 if θ is high and closer to 1 if θ is low (in other words: if the amount of turn is low, then the acceleration magnitude has a higher weight; if the amount of turn is high, then the acceleration magnitude has a lower weight).

Alternatively, this composite measure Σ can be determined through fuzzy logic.

The composite measure Σ is reflects similarity of movement between nodes and is therefore well suited as a semantic property for clustering nodes.

In one particular embodiment, the invention provides a wireless motion sensor network, wherein the angle between the first orientation and the second orientation of the sensor node are determined by taking a first compass reading and a second compass reading and calculating the arccosine of the dot product of the first and second compass readings.

In a further embodiment, a wireless motion sensor network is provided, wherein the composite measure (Σ) is used as the semantic property that is input to the clustering means of at least two sensor nodes in order to determine whether the at least two sensor nodes should form a cluster based on the similarity of motion.

The present invention also provides a wireless motion sensor network, wherein the collaborative reasoning means take a number of features as input that are redundant or even overlapping, wherein the features are aggregated by determining a majority quantification, the majority quantification expressing an amount for the features that is supported by the majority of the input features.

This feature provides complex, high-level situation assessment based on fusing multiple, even redundant or overlapping features from sensor nodes. It can also take into account temporal knowledge and fuzzy concepts.

When nodes execute a higher-level reasoning, then the confidence measures that they compute and broadcast are used for the collaborative reasoning.

When multiple sensor nodes extract the same type of features and execute similar local information processing, then a majority quantification mechanism is used to aggregate what they report into a consensual information. Depending on the application, the sensor nodes can include temporal knowledge in the collaborative reasoning process. This would be the case when the situation to be assessed can be decomposed into logical steps that should occur in a certain order or within certain time intervals.

Temporal knowledge can add useful information to the collaborative reasoning process and increase the chance of assessing correctly the observed situation. Because features can be associated with the time intervals of their occurrences, temporal knowledge is typically based on time intervals. As a consequence, the temporal rule set can impose time constraints on a specific feature F, such as:
F should occur during time interval [t₁, t₂];
F should occur before or after time t or time interval [t₁, t₂];
F duration should be less, equal or more than t seconds.

Because the extraction of features from the continuous stream of sensor data has a certain accuracy, it is natural to express these time constraints in a fuzzy manner. We can give then nuances such as approximately during, long before or soon after to the time constraints defined above.

An important aspect of temporal knowledge is the temporal order. In this case, the observed situation is analyzed based on a given sequence of steps. In other words, the features extracted and reported by the sensor nodes should occur in a certain ordered sequence. This sequence is application-specific. Adding temporal order knowledge to the collaborative reasoning process can improve significantly the overall assessment accuracy, by distinguishing between situations that consist of similar features, but those features occur in different ordered sequences. Quantifiers as previously defined (before, after) can be used to specify temporal order relations. In addition, the concept of inversion is important to quantify how well the observed order of steps matches the expected (application-specific) order of steps. Let us consider situation S, defined as a sequence of features that should occur in the following order:

S=F₁<F₂< . . . <Fₖ

where F₁, F₂, . . . , Fₖ are the features and “<” is the order relation (before).

In the observed situation S′, any pair Fᵢ, Fⱼ is considered an inversion if:

Fᵢ<Fⱼ in S′ and Fⱼ<Fᵢ in S

in other words, instead of having Fⱼ before Fᵢ, as defined by the application logic, Fᵢ occurs before Fⱼ.

The number of inversions can be subsequently used as a measure of how well the observed features match the application-specific order of steps in a given situation. This measure can be expressed as a fuzzy measure.

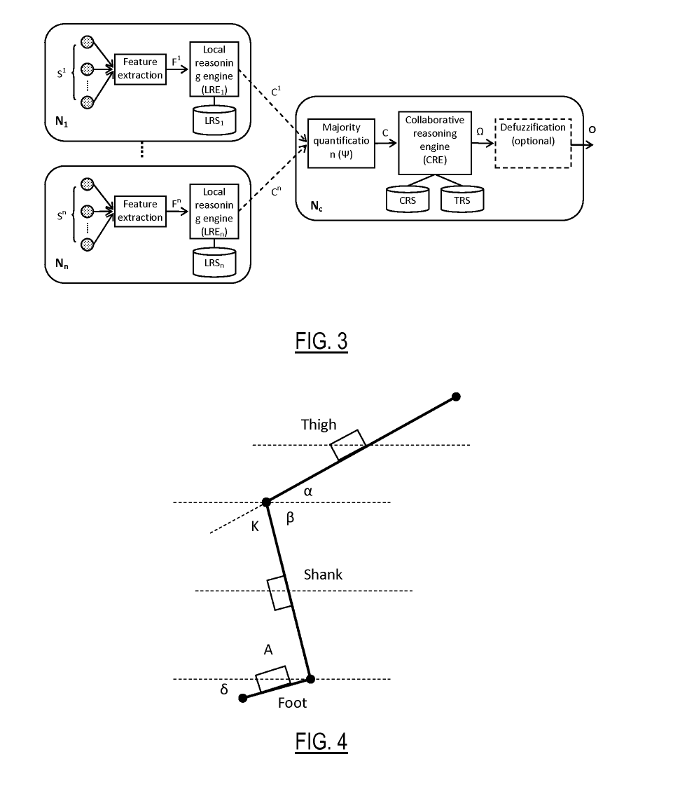

FIG. 3 shows the architecture of the complex collaborative reasoning process, where several mechanisms previously introduced are present: feature extraction, local reasoning, majority quantification and temporal knowledge.

In the case when fuzzy logic is used throughout the whole reasoning chain, the procedure is as follows:

1) The nodes broadcast the features processed through their local reasoning engine. Formally, considering a node Nᵢ and a feature F, Nᵢ will compute and transmit the fuzzy values μ_{F}(Nᵢ), using the membership functions locally defined.

2) For each feature F that is reported by multiple nodes N^{F}={N₁, N₂, . . . , Nₖ}, the majority quantification (W) proceeds in two steps:
a. First, the sigma-count factor is computed as:

$${\sum }^{ } Count ( F ) = {\sum }_{i = 1}^{k} {μ}_{F} ( {N}_{i} )$$

Optionally, the observations of the nodes can be given different weighting factors wᵢ, based for example on the accuracy of their sensors. In this case, we have a weighted sigma-count factor:

$${\sum }^{ } Count ( F , w ) = {\sum }_{i = 1}^{k} {w}_{i} {μ}_{F} ( {N}_{i} )$$

b. Second, a fuzzy majority quantifier is applied. Such a quantifier is most, used in social preference relation studies, defined as the following function:

$${μ}_{most} ( x ) = \{ \begin{matrix}0 , & if x \leq 0.3 \\ 2 x - 0.6 , & if 0.3 < x < 0.8 \\ 1 , & if 0.8 \leq x\end{matrix}$$

The result of the majority quantification can be written as:

$${μ}_{most} ( \frac{{\sum }^{ } Count ( F , w )}{‖ {N}^{F} ‖} ) = {μ}_{most} ( \frac{{\sum }_{i = 1}^{k} {w}_{i} {μ}_{F} ( {N}_{i} )}{k} )$$

3) The quantified fuzzy inputs are now processed through the set of IF-THEN rules. The temporal knowledge rule set is also utilized to check the matching between the occurrence of features and the application-specific time constraints. For the fuzzy inference process, it only matters that we have a number of inputs that characterize the “values” of the features and a number of inputs that characterize the “timing” of the feature occurrences.

4) The results of the IF-THEN rules are combined into an aggregate fuzzy output, using for example max-min or sum-product fuzzy inference methods.

5) The aggregate fuzzy output is defuzzified back to a crisp number that can be used for making decisions or taking control actions.

In another embodiment, the invention provides a wireless motion sensor network, wherein the majority quantification is done in fuzzy logic and the result is used in fuzzy inference during collaborative reasoning.

In a further embodiment according to the invention, a wireless motion sensor network is provided, wherein the temporal knowledge, for example temporal order constraints, is used in the collaborative reasoning in addition to the derived features.

In again a further embodiment a wireless motion sensor network is provided, wherein the temporal knowledge, for example the temporal order constraints, is expressed by means of fuzzy variables.

The present invention also provides a wireless sensor node for use in a wireless motion sensor network as described above.

In another embodiment, the invention provides a reasoning node for use in a wireless motion sensor network as described above.

According to a further embodiment, the present invention provides a feedback and/or actuation node for use in a wireless motion sensor network as described above. The feedback and/or actuation node is in a particular embodiment a dedicated node. In an alternative embodiment, it is a combined node also comprising a sensor node and/or a reasoning node.

Once the collaborative reasoning process yields an output, the wireless motion sensor network does one or more of the following:
stores the data associated with the current situation in non-volatile memory, for later analysis;
reports the situation to one or more data gathering points. Such data gathering points can be remote computers, for example belonging to the healthcare centre that monitors the training regime of the user;
controls the corresponding feedback (in any form—audio, video, tactile) to the user, by interacting with input-output interfacing devices;
acts upon the environment through actuators, thus introducing a sensor-actuator control loop.

Feedback and actuation introduce a distributed control loop between the sensor network, on the one hand, and the various interfacing devices and actuators, on the other hand. To complete the fuzzy logic chain, this control loop may be implemented using fuzzy control techniques.

Further embodiments and advantages will be discussed below according to the accompanying figures, wherein:

FIG. 1 shows a high level architecture of a wireless motion sensor network according to the present invention;

FIG. 2 shows a flow chart for measuring features in repetitive motions as performed by sensor nodes according to the present invention;

FIG. 3 shows an overview of the architecture of the collaborative reasoning as applied in the present invention;

FIG. 4 shows an example of the present application being applied to monitor the movement of the thigh, shank, and foot of a cyclist;

FIG. 5 shows an embodiment of a sensor node according the present invention, wherein for the application of FIG. 4, the angle is determined between a first orientation of the sensor node and a second orientation;

FIG. 6 shows an example of the present application being applied to monitor the movement of a weight by a person exercising;

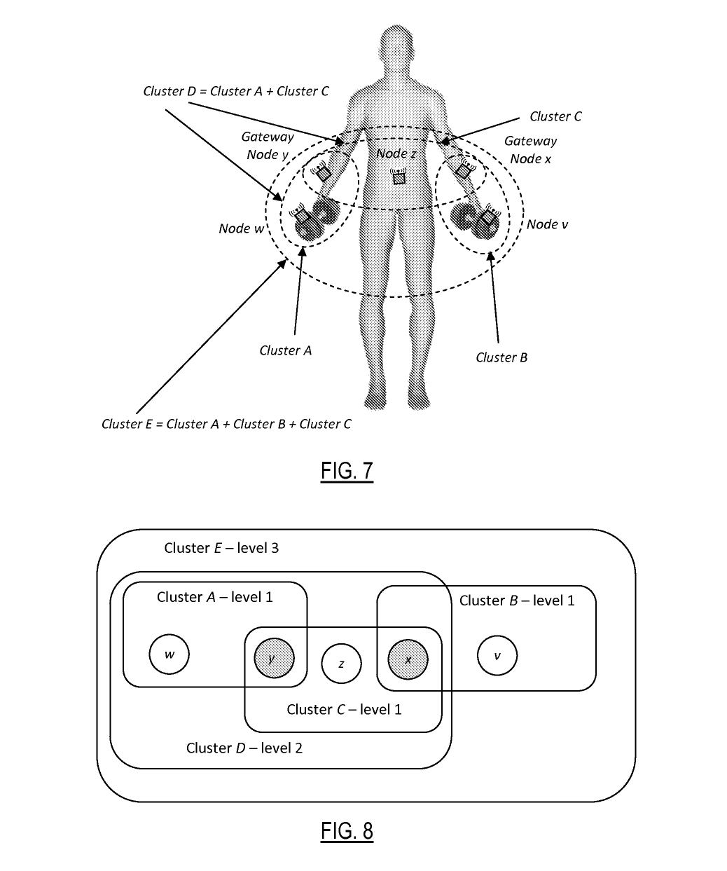

FIG. 7 shows how a wireless motion sensor network according to the invention clusters sensor nodes;

FIG. 8 shows an abstract representation of the clustering from the previous figure.

FIG. 1 depicts the high-level architecture of the system. The functional blocks are represented as boxes. The typical functional flow is represented with solid arrows. Optional functional connections are drawn with dotted lines. FIG. 1 starts from the environment characteristics and process motions that are sensed by the wireless motion sensor network, and continues with:

1) Local processing of sensor information, executed on each sensor node;

2) Ad-hoc network organization into clusters, based on related semantic properties established by the sensor nodes using the results of local information processing;

3) Situation assessment, performed as collaborative reasoning, using the results of local information processing of sensor nodes and, optionally, the semantic ad-hoc network organization; and

4) Feedback to the user and actuation decisions, which are triggered by the results of the situation assessment and/or, optionally, by the results of local information processing and/or the semantic ad-hoc network organization.

FIG. 4 shows an example application of the present invention. The primary objective of this cycling application is to measure the orientation of the lower limbs of the cyclists relative to the Earth reference frame, in terms of roll-pitch-yaw angles (also known as Euler angles). Assuming a three-segment decomposition of the lower limb of a human, a possible attachment of the sensor nodes is on the thigh, shank and foot of the person. Each sensor node has an accelerometer, gyroscope and magnetometer attached and can compute its orientation relative to a fixed reference frame. By combining the orientation of each node, the joint motions of the three segments of the lower limb can be obtained.

FIG. 6 shows a further example of an application of the present invention. This example concerns people that have to maintain a certain level of physical training. These persons are assisted in their physical training regime by a wireless motion sensor network. Let us assume that Bob is such a person and he performs training with weights, comprising different lifting movements. A certain sequence of movements has to be maintained. The number of movements of each type should be between a specified minimum and maximum, so that to ensure the proper effect while preventing excesses. The correctness of lifting movements is also very important to ensure an optimal training. In this example Bob performs a weight lifting exercise. Sensor node w monitors the movement of the weight and determines whether the exercise is performed correctly.

FIG. 7 shows an example of the clustering of sensor nodes. The user, Bob, has two sensor nodes x and y with accelerometers and gyroscopes attached to his wrists (node x on the left hand, node y on the right hand), and one sensor node z with accelerometer attached to his belt. Bob starts walking towards the exercise room. Nodes x, y and z compute the coherence function based on accelerometer data and decide that they experience the same frequency of stepping. They group together in level 1 cluster C. In the exercise room, there are two weights, each of them having an integrated sensor node with gyroscope (nodes v and w). Bob picks up with both hands the two weights from the exercise room. He grabs the weight with node v with the left hand and the weight with node w with the right hand. At this moment, nodes y and w compute the correlation of the gyroscope signals and determine that they have a similar angular velocity. They decide that they move together and form cluster A. The same clustering process is experienced by nodes x and v, thus forming cluster B. These two clusters are the level 1 clusters.

However, clusters A and C have node y in common, and therefore a new cluster is constructed (Cluster D, at level 2), comprising nodes w, x, z and y. Cluster D and Cluster B have node x in common, and thus a new cluster of level 3 is built—Cluster E, which comprises all the nodes attached to or worn by Bob. In a similar way, higher level clusters can be formed if, for example, Bob is training together with a group of people.

FIG. 8 shows the clustering of the nodes in a more abstract way: Based on property A, nodes w and y cluster together into level 1 cluster A. Based on property B, nodes x and v cluster into level 1 cluster B. Based on property C, nodes x, y and z cluster into level 1 cluster C. Nodes x and y belong to two different clusters, therefore they are gateway nodes. Node y connects clusters A and C into level 2 cluster D. Node x connects clusters B and D into level 3 cluster E.

The embodiments shown and described herein are included for illustrative purposes only and should be regarded as examples only. These embodiments are not to be regarded as an exhaustive presentation of the invention. The person skilled in the art will recognise that many alterations to and modifications of the embodiments are possible within the scope of the invention. For example, the embodiments shown and described can be combined into new embodiments of the present invention. Furthermore, the invention can be practiced in different application domains: for example healthcare/rehabilitation, where the movements of patients are monitored and feedback is provided with regard to the quantity of movements and the quality of movements (for example, the patient could be notified if some movement is performed incorrectly), sports training (for example practicing a golf swing), robotics (for example training a robot by example), logistics (monitoring the movements undergone by goods). The scope of protection sought is therefore only limited by the following claims.

What is claimed is:

1. Wireless motion sensor network for monitoring motion in a process comprising:
at least one wireless sensor nodes comprising:
at least one sensor for measuring at least one physical quantity related to motion or orientation,
feature extraction means connected to the at least one sensor for deriving a feature from the measured quantities,
a wireless transmitter connected to the feature extraction means for transmitting the derived feature, and
wireless receiver for receiving derived features from other sensor nodes,
a reasoning node for collecting features transmitted by the at least one wireless sensor node, comprising:
a wireless receiver for receiving transmitted features,
a collaborative reasoning engine for determining further features based on features received by the wireless receiver, wherein the further features are determined by calculation and/or a rule set comprising at least one rule,
feedback and/or actuation means for intervening in or influencing the monitored process comprising:
communication means for receiving output of a collaborative reasoning engine from a reasoning node,
feedback means for providing a feedback signal to an user based on the output of the collaborative reasoning engine, and/or
an actuator for controlling a process input based on the output of the collaborative reasoning engine.

2. Wireless motion sensor network according to claim 1, wherein the sensor node further comprises:
semantic property derivation means for deriving a semantic property based on at least one of: raw sensor data, a derived feature, a confidence measure computed from at least one feature, and the proximity to other sensor nodes, and wherein
the wireless transmitter is connected to the semantic property derivation means for transmitting the derived semantic property
the wireless receiver is further configured to receive semantic properties from other sensor nodes;
the sensor node further comprising:
clustering means connected to the semantic properties derivation means and the wireless receiver for dynamically forming clusters with other sensor nodes based upon common semantic properties.

3. Wireless motion sensor network according to claim 2, wherein the dusters as formed according to claim 2 form a first hierarchical level, and wherein the sensor nodes are configured to form a higher level cluster by clustering the nodes of two lower level clusters that have at least nine sensor node in common.

4. Wireless motion sensor network according to claim 2, wherein the collaborative reasoning engine only combines derived features originating from sensor nodes from a common cluster.

5. Wireless motion sensor network according to claim 1, wherein the sensor node and reasoning node are combined into a single node.

6. Wireless motion sensor network according to claim 1, wherein the reasoning node and the feedback and/or actuation node are combined into a single node.

7. Wireless motion sensor network according to claim 1, wherein a sensor node determines whether the node is in one of the following states when the sensor node undergoes a repetitive motion:
a static reference position characterised by a sensor output showing or at least hinting at the absence of motion
an extreme position characterised by a sensor output showing or at least hinting at the sensor having reached a minimum or a maximum position within a range of motion; and
a continuous motion characterised by a sensor output showing or at least hinting at the sensor being in motion between two extreme positions.

8. Wireless motion sensor network according to claim 7, wherein a sensor node calibrates a sensor or a feature during a determined static reference position by making use of the knowledge that the sensor node is motionless.

9. Wireless motion sensor network according to claim 7, wherein the sensor node calibrates a sensor or a feature by assuming a value at a determined extreme position.

10. Wireless motion sensor network according to claim 1, wherein the sensor node further comprises a local reasoning engine connected to the feature extraction means for determining a confidence measure expressing the confidence that a particular situation has occurred based upon a reasoning process, the local reasoning engine being further connected to the wireless transmitter for transmitting the confidence measure.

11. Wireless motion sensor network according to claim 1, wherein a determined feature is expressed as a fuzzy variable comprising at least one fuzzy value.

12. Wireless motion sensor network according to claim 11, wherein a fuzzy variable of a feature is used in the collaborative reasoning engine of a reasoning node as an antecedent to a fuzzy if-then implication that outputs a fuzzy output.

13. Wireless mot on sensor network according to claim 11, wherein multiple fuzzy variables are aggregated into a single fuzzy output through a fuzzy inference process.

14. Wireless motion sensor network according to claim 11, wherein a fuzzy output is defuzzified to a crisp output.

15. Wireless motion sensor network according to claim 1, wherein a sensor node determines an amount of turn by determining the angle between a first orientation of the sensor node and a second orientation of the sensor node, and wherein
the sensor determines a composite measure (Σ) comprised of the weighted summation of the magnitude of the observed acceleration (A) and the determined amount of turn (θ), wherein the weighting is performed with a weighting function (f(θ)) dependent on the amount of turn (θ): and
the composite measure (Σ) is provided as a feature.

16. Wireless motion sensor network according to claim 15, wherein the angle between the first orientation and the second orientation of the sensor node are determined by taking a first compass reading and a second compass reading and calculating the arccosine of the dot product of the first and second compass readings.

17. Wireless motion sensor network according to claim 15, wherein the composite measure (Σ) is used as the semantic property that is input to the clustering means of at least two sensor nodes in order to determine whether the at least two sensor nodes should form a cluster based on the similarity of motion.

18. Wireless motion sensor network according to claim 1, wherein the collaborative reasoning means take a number of features as input that are redundant or even overlapping, wherein the features are aggregated by determining a majority quantification, the majority quantification expressing an amount for the features that is supported by the majority of the input features.

19. Wireless motion sensor network according to claim 18, wherein the majority quantification is done in fuzzy logic and the result is used in fuzzy inference during collaborative reasoning.

20. Wireless motion sensor network according to claim 18 wherein the temporal knowledge, for example temporal order constraints, is used in the collaborative reasoning in addition to the derived features.

21. Wireless motion sensor network according to claim 20, wherein the temporal knowledge, for example the temporal order constraints, is expressed by means of fuzzy variables.

22. Wireless sensor node for use in a wireless motion sensor network for monitoring motion in a process comprising:
at least one wireless sensor nodes comprising:
at least one sensor for measuring at least one physical quantity related to motion or orientation,
feature extraction means connected to the east one sensor for deriving a feature from the measured quantities,
a wireless transmitter connected to the feature extraction means for transmitting the derived feature, and
a wireless receiver for receiving derived features from other sensor nodes,
a reasoning node for collecting features transmitted by the at least one wireless sensor node, comprising:
a wireless receiver for receiving transmitted features,
a collaborative reasoning engine for determining further features based on features received by the wireless receiver, wherein the further features are determined by calculation and/or a rule set comprising at least one rule,
feedback and/or actuation means for intervening in or influencing the monitored process comprising:
communication means for receiving output of a collaborative reasoning engine from a reasoning node,
feedback means for providing a feedback signal to an user based on the output of the collaborative reasoning engine, and/or
an actuator for controlling a process input based on the output of the collaborative reasoning engine.

23. Reasoning node for use in a wireless motion sensor network for monitoring motion in a process comprising:
at least one wireless sensor nodes comprising:
at least one sensor for measuring at least one physical quantity related to motion or orientation,
feature extraction means connected to the at least one sensor for deriving a feature from the measured quantities,
a wireless transmitter connected to the feature extraction means for transmitting the derived feature, and
a wireless receiver for receiving derived features from other sensor nodes,
a reasoning node for collecting features transmitted by the at least one wireless sensor node, comprising:
a wireless receiver for receiving transmitted features,
a collaborative reasoning engine for determining further features based on features received by the wireless receiver, wherein the further features are determined by calculation and/or a rule set comprising at least one rule,
feedback and/or actuation means for intervening in or influencing the monitored process comprising:
communication means for receiving output of a collaborative reasoning engine from a reasoning node,
feedback means for providing a feedback signal to an user based on the output of the collaborative reasoning engine, and/or
an actuator for controlling a process input based on the output of the collaborative reasoning engine.

24. Feedback and/or actuation node for use in a wireless motion sensor network for monitoring motion in a process comprising:
at least one wireless sensor nodes comprising:
at least one sensor for measuring at least one physical quantity related to motion or orientation,
feature extraction means connected to the at least one sensor for deriving a feature from the measured quantities,
wireless transmitter connected to the feature extraction means for transmitting the derived feature, and
a wireless receiver for receiving derived features from other sensor nodes,
a reasoning node for collecting features transmitted by the at least one wireless sensor node, comprising:
a wireless receiver for receiving transmitted features,
a collaborative reasoning engine for determining further features base on features received by the wireless receiver, wherein the further features are determined by calculation and/or a rule set comprising at least one rule,
feedback and/or actuation means for intervening in or influencing monitored process comprising:
communication means for receiving output of a collaborative reasoning engine from a reasoning node,
feedback means for providing a feedback signal to an user based on the output of the collaborative reasoning engine, and/or
an actuator for controlling a process input based on the output of the collaborative reasoning engine.
